(19) United States
(12) Patent Application Publication
(10) Pub. No.: US 2005/0207616 A1
(43) Pub. Date: Sep. 22, 2005

(54) Movable barrier operator with an obstacle detector

(75) Inventors: Dana Brad, Frankfort, IL (US); Eric Gregori, Lindenhurst, IL (US)

Correspondence Address: FITCH EVEN TABIN AND FLANNERY, 120 SOUTH LA SALLE STREET, SUITE 1600, CHICAGO, IL, 60603-3406, US

(73) Assignee: The Chamberlain Group, Inc.

(21) Appl. No.: 10/802,502

(22) Filed: Mar. 17, 2004

(51) Int. Cl. G06K 9/00

(52) U.S. Cl. 382/103

(57) ABSTRACT

A movable barrier operator comprises a pattern generator for projecting a beam across the barrier path; a CCD camera for recording a pattern produced by projected beam across the barrier path; and a controller for sensing when the pattern produced by projected beam is changed by presence of an obstacle, and generating an obstacle detection signal in response thereto. The movable barrier operator is responsive to the obstacle detection signal to control the barrier drive.

### BACKGROUND OF THE INVENTION

This invention relates generally to movable barrier operators and more particularly to an obstacle sensing system adapted to project a light beam across part of the surface of the barrier opening to detect the presence of obstacles.

Movable barrier operators that serve to control movement of movable barriers (including but not limited to garage doors of all types, gates, shutters, and so forth) are well known and understood in the art. It is known to use infrared detectors installed at the sides of the barrier opening and aligned across a barrier opening area to shine a narrow beam across an opening and detect obstruction. One of the detectors, an IR source sends an IR beam through open space to a receiver, or IR sensor aligned with the IR source located across the barrier opening. Upon sensing the absence of the IR beam at the sensor, indicating an obstacle, movement of the movable barrier can be altered. However, the function of the IR detectors is limited to detecting an interruption of the IR beam, and the detectors need precise alignment, which provide certain difficulties during their installation.

There is a need for a simple, inexpensive detection device which is easy to install and which is able to detect intrusions and obstacles in a defined area as well as to provide other functions such as determining the position of the barrier and the velocity of the barrier movement when used with a barrier movement operator.

### BRIEF DESCRIPTION OF THE DRAWINGS

FIG. 1 shows a barrier system having a pattern light source and detector;

FIG. 2 shows a light beam pattern in absence of an obstacle adjacent to the defined area;

FIG. 3 shows a second arrangement for producing and sensing a light pattern with an obstacle in the defined area;

FIG. 4 shows an image of a light pattern in presence of an obstacle;

FIG. 5 shows an embodiment which includes light beam pattern on a side portion of the door opening;

FIG. 6 shows projection of a light pattern on a floor at an opening and sensing apparatus in a housing of a barrier movement operator; and

FIG. 7 illustrates observing a defined area through which a pattern is projected.

### DESCRIPTION

A system for detecting an object may comprise an optical source projecting a pattern across a defined area and producing a light pattern; a digital imaging device, which may be a CCD camera, for detecting the light pattern produced by the optical source projection, and a controller responsive to detected patterns over time to identify obstructions to barrier movement. The controller may comprise a memory with a stored image of a non-obstruction pattern which may be compared to periodicly scanned patterns. The CCD camera is installed at an off-set angle from projecting device. The pattern may be straight line in absence of an object in the defined area and when the object enters the defined area and the straight line pattern of the light beam is changed when an object enters the defined area and changes the pattern of the light beam produced by the laser device, the controller senses the difference between the image of the pattern stored in the memory and the digital representation of the pattern detected by the imaging device, and a signal is sent to an alarm unit.

A method of detecting an object in a defined area using a pattern source and a digital imaging device may comprise steps of: shining the pattern source across the defined area and producing a light pattern; detecting an image of light pattern by a digital imaging device at an off-set angle to the pattern source generator; and periodically comparing the newly detected patterns with previously detected patterns. The system of the present invention may be also employed by a barrier operator for moving a barrier along a barrier path between open and closed positions to detect obstacles to the barrier movement. The barrier operator comprises a pattern source generator shining a pattern across the barrier path; a digital imaging device for recording a pattern produced by shining the pattern across the barrier path; and a controller for sensing when the pattern produced by the source is changed by presence of an obstacle, and generating an obstacle detection signal in response thereto. An alarm may also be connected to the controller for actuation by the controller when the pattern produced by the source shining across the path varies from the original pattern.

The system for detecting obstacles includes a pattern source device such as a scanning laser and a digital imaging device such as CCD camera.

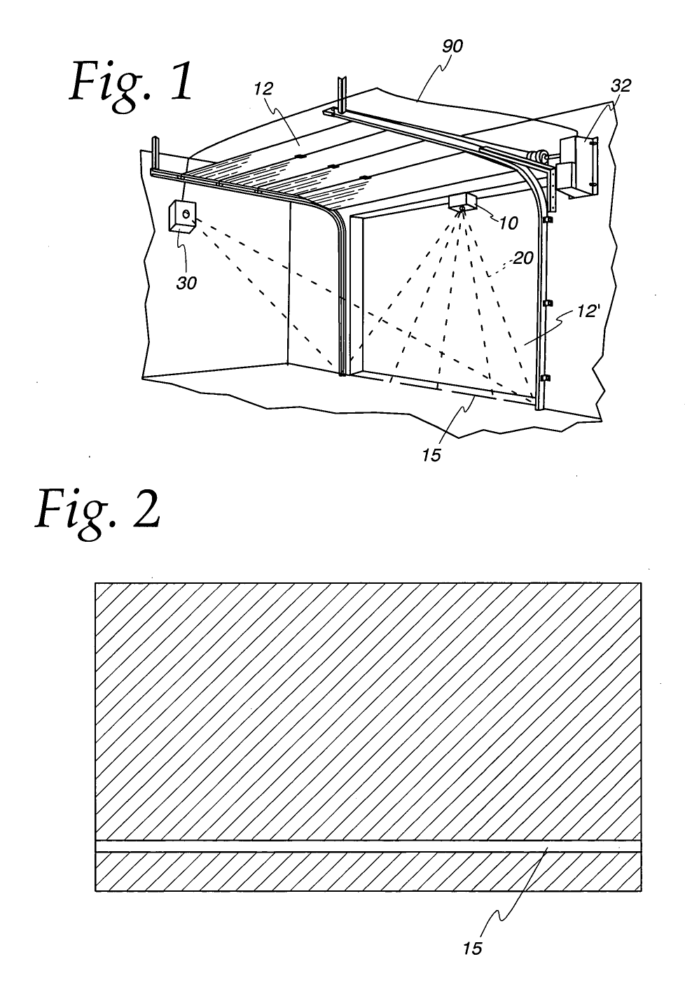

FIG. 1 shows a system for detecting an obstacle in a defined area using a pattern source such as a scanning laser in the path of a movable barrier, such as a garage door. The garage door opening is scanned by a light pattern from a pattern source 10 mounted in such a location to easily illuminate the garage door opening for detection of obstacles in the way of the moving garage door. The pattern source 10 is installed in a location which allows coverage of the garage door opening, and may, for example, be installed above the garage door (FIG. 1), on the head unit of the garage door operator, or mounted on the garage wall or ceiling (FIG. 3), etc. The pattern source 10 contains at least one light source, which projects a beam pattern of laser light 20 across the door opening. Although the light from pattern source 10 shines through much of the door opening 12′, such pattern is largely invisible in the opening due to the transparency of the air and, in absence of an obstacle, creates a straight illuminating line 15 on the lower surface of the garage door opening. The light reflected from the lower surface of the garage door opening is viewed from an angle by a CCD camera 30.

In general, the CCD camera may be located outside or inside the garage at an angle to the garage opening. In the embodiment shown in FIG. 1, a CCD camera 30 is mounted on the garage wall inside the garage at an angle to the garage door opening so that to view the light pattern 15 produced across the door opening by the pattern source 10. Although other focused light sources may be used, pattern source 10 of the present embodiment comprises a laser which may be, for instance, a bright 5 mW at 635 nm laser diode, and a mirror, which rotates inside the unit (not shown), providing a unidirectional scan within an angle of about 90° across the scanning zone, which is the door opening. The pattern generator may work from power from the garage door operator, built-in batteries, or from a AC power source. The light pattern 15 in absence of an obstacle is a straight illuminated line across the bottom of the garage door opening 12′, as shown in FIG. 2.

The CCD camera of the present embodiment has a rectangular frame which includes a lens and charge-coupled device (CCD) to receive incoming light. The CCD camera includes a digital processor for processing images from the CCD, and a memory. Further, the camera is coupled to a controller as may be present in a barrier movement operator housing 32. The coupling may be by attached wires 90 as shown or by a wireless link. The CCD is a solid-state electronic component which is micro-manufactured and segmented into an array of individual photosensitive elements, or “pixels.” The more common CCDs found in camcorders and other retail devices have a pixel array that is a few hundred pixels high by a few hundred pixels wide (e.g., 500×300, or 320×200), yielding tens of thousands of pixels. Since most CCDs are only about ¼″ or ⅓″ square, each of the many thousands of pixels are only about 10 millionths of a meter (about 4 ten-thousandths of an inch) wide. The CCD photosensitive elements accomplish their task of sensing incoming light through the photoelectric effect releasing electrons when hit with photons of light. The electrons emitted within the CCD are fenced within nonconductive boundaries, so that they remain as electric charge within the area of the photon strike. As long as light is allowed to impinge on a photosensitive element, charge will accumulate in that pixel. When the source of light is extinguished, e.g., a shutter is closed, or an obstacle interrupts the light beam, a simple electronic circuit and a microprocessor or computer are used to unload the CCD array, record the amount of charge in each pixel, and process the resulting data into an image, or a digital representation, digital “map” of an image.

Another type of a CCD camera, which may be used in the present application is a line scan camera. A line scan camera is an image capturing device having a CCD sensor which is formed by a single line of photosensitive elements, pixels. Therefore, unlike area sensors which generate frames, in this case the image acquisition is made line by line. One single scanning line of a line scan device can be considered as a one-dimensional mapping of the brightness related to every single point of an observed line. A linear scanning generates a line, showing on the Y axis the brightness of each point given in grey levels (from 0 to 255 levels). A sudden change of the grey level in a single point corresponds either to a point on the edge of an object or to any color or aspect variation of the acquired image. Detection of this change allows a precision measurement, due to the high resolution on the linear sensor, which is considerably better than the resolution of an area sensors. For instance, by using a backlight, the position of a strip can be easily detected.

The CCD functions as follows. First, the CCD camera 30 is generally aimed onto the low level of the door opening 12′ illuminated by the pattern source 10. Camera (detector) 30 is located at an angle to the source 10 and scans the pattern 15, which is a substantially straight light line on the bottom of the garage opening 12′ (FIG. 1) in absence of an obstruction. The CCD camera 30 records the straight light pattern 15 and stores the image of said pattern 15 in the memory. Later, when the camera is observing the door opening 12′ with a light pattern, the images of the laser light pattern are analyzed by the software of the processor and correlated pixel by pixel with the image of the pattern 15 stored in the memory, so that the digital representation of the light pattern 15 is recognized by the camera. To aid in pattern recognition the CCD 30 may include an optical filter tuned to a primary light frequency of the light projected from source 10. Further, the CCD 30 may periodically view the opening with the source 10 turned off to obtain a “base line” image. The “base line” image can then be subtracted from the image received when the source is on to isolate the line 15.

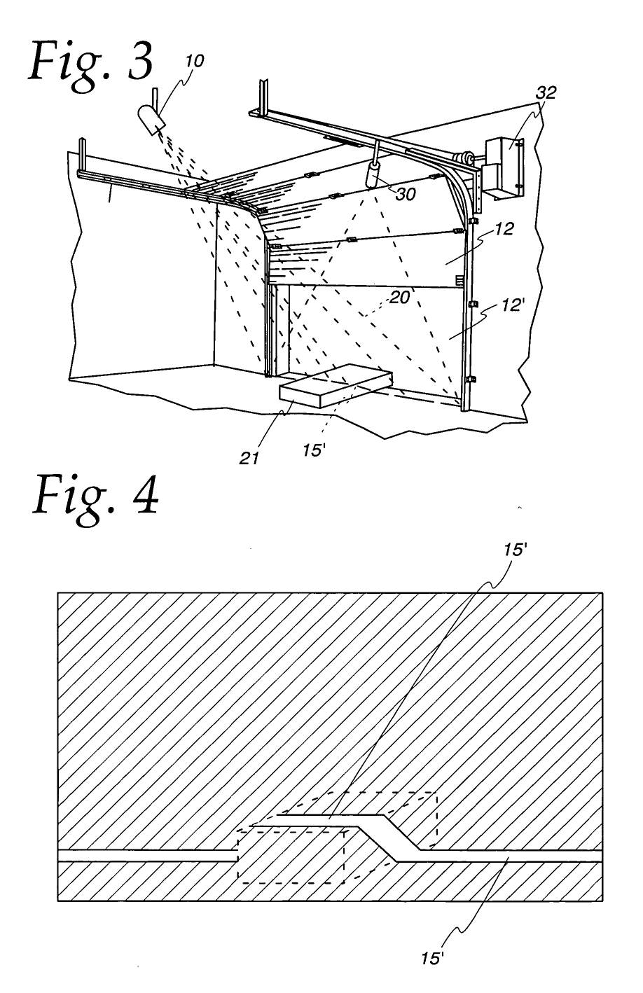

FIG. 3 shows an embodiment in which the source 10 is installed on the ceiling of the garage, and the light pattern is observed by a camera positioned inside the garage at an angle to the garage opening. When an object, such as a box 21 comes into the garage door opening, the CCD camera 30 observes a changed light pattern 15′, as shown in FIGS. 2 and 4. The software analyzes the digital representations of the light pattern 15′ by correlating with the stored image of pattern 15 to identify whether a change in the detected line 15 to 15′ is an obstruction. When the past and present images are sufficiently different, the object 21 is considered an obstacle, and an obstruction signal is sent to the garage door operator 32. The operator 32 if moving the barrier may respond to the obstruction signal by stopping and/or reversing a moving barrier, it may inhibit motion of the barrier or it may signal an audible or visual alarm.

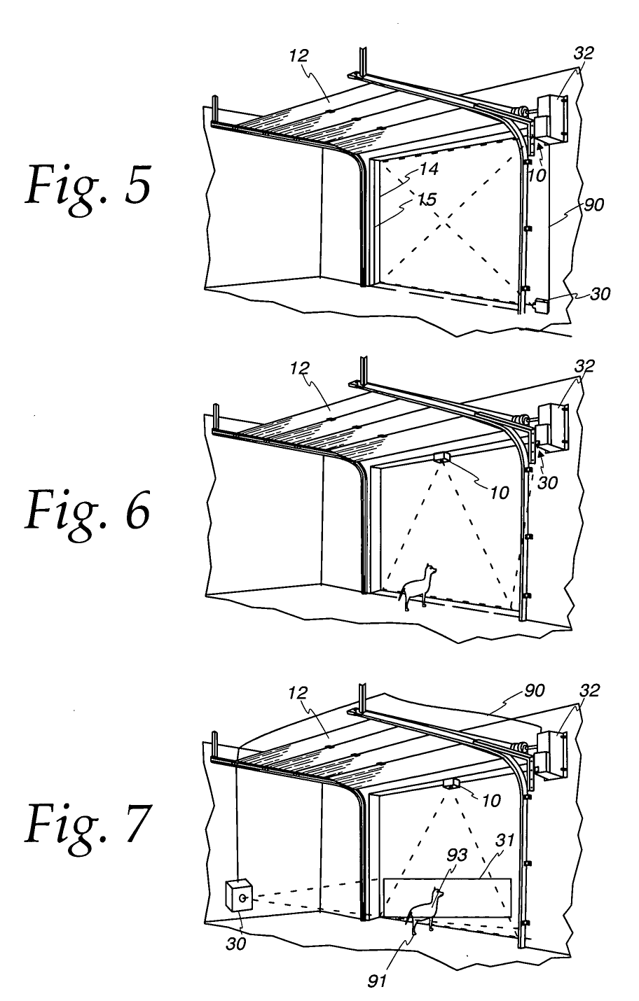

FIG. 5 illustrates a different arrangement for the light pattern generator and detector. In FIG. 5 the light pattern 15 is projected from the barrier movement operator 32, across doorway 12′ onto a portion of the door frame 14. A pattern detector 30 is attached below the barrier movement operator and detects obstructions as discussed with regard to FIGS. 1-4. FIG. 6 illustrates an arrangement where the light pattern is projected from 10 across the door opening and the detector 30 is mounted at the barrier movement operator.

In another embodiment, the camera is mounted at the door, and the pattern generator is installed at the head unit at an angle to the camera. In this case the distance to the bottom of the door opening may also be computed from the light patten image pixel data.

In yet another embodiment the pattern generator is mounted on the garage door, and the camera is mounted at the head unit.

The preceding examples have discussed the projection of a pattern across a barrier opening onto a surface and the detection of obstructions by detecting changes in the observed pattern. The presently disclosed system functions also if the pattern is projected onto a surface which is not observed by the detector 30 or projected across the barrier opening “into space” with no surface showing the pattern.

FIG. 7 represents an embodiment in which the source 10 projects a pattern across the barrier opening 12′ and onto the floor at 15. The optics of the detector 30 are controlled to observe in a rectangular zone 31 through the barrier opening. The pattern is projected through the rectangular zone. When no obstruction is present the detector 30 will detect a constant background with no detected lines. When an obstruction such as animal 91 walks through the projected patterns at the rectangle 31 a pattern of projected light 93 will be observed by camera 30 and detected. As discussed above the detection of the line 93 can be enhanced by optically filtering the input to detector 30 and/or creating a digital base line by observing an obstruction free opening with the light source on and off.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

1. A barrier operator for moving a barrier between open and closed positions with respect to a barrier opening, comprising:
a light pattern generator to project an optical pattern across the barrier opening;
an imaging device to observe a portion of the barrier opening as illuminated by the optical pattern; and
a controller coupled to the imaging device to sense when the optical pattern in the observed portion of the barrier opening changes, and generating a detection signal in response thereto.

2. The barrier operator of claim 1, comprising apparatus for periodically recording images detected by the imaging device.

3. The barrier operator of claim 2, wherein the controller periodically compares an observed pattern detected by the imaging device with a digital representation of a non-obstacle pattern previously detected and recorded.

4. The barrier operator of claim 3, wherein the non-obstacle pattern is a substantially straight line.

5. The barrier operator of claim 1, wherein the digital imaging device observes the barrier path at an angle to the scanning device.

6. The barrier operator of claim 1, comprising an alarm device to generate an alarm indication in response to the detection signal.

7. The barrier operator of claim 6, wherein the alarm indication is an audible signal.

8. The barrier operator of claim 6 wherein the alarm indication is a visual signal.

9. The barrier operator of claim 1, comprising a barrier drive unit for moving the barrier, and wherein the controller is responsive to the detection signal to control the barrier drive.

10. The barrier operator of claim 1, wherein the light pattern generator comprises:
a source of electrical energy;
a laser diode; and
an optical lens to focus a beam generated by the laser diode.

11. The barrier operator of claim 1, wherein the imaging device is a CCD camera.

12. The barrier of claim 1, wherein the light pattern generator is disposed on the barrier.

13. The barrier operator of claim 1, comprising a head unit with a motor for moving the barrier, and the imaging device is disposed on the head unit.

14. A system for detecting an object, comprising:
a light pattern generator projecting a light pattern beam across a defined area and producing a light pattern in the defined area;
a digital imaging device for detecting the light pattern produced by the light pattern generator; and
a controller having a memory with a stored image of a non-obstruction pattern detected in the defined area as produced by the light pattern generator; and
the controller periodically compares said image stored in the memory with the light pattern detected by the imaging device produced by the light beam shining across the defined area and recorded by the digital imaging device.

15. The system of claim 14, wherein, when the controller detects a difference between the digital representation of the light pattern produced by detecting the defined area and the image stored in a memory, the controller initiates an alarm.

16. The system of claim 14, wherein the image stored in the memory is of a substantially straight line produced by the pattern generator in absence of an object in the defined area.

17. The system of claim 16, wherein the digital imaging device is a CCD camera, which is installed at an off-set angle from the laser device.

18. A method of detecting an object in a defined area using a light pattern generator and a digital imaging device, comprising steps of:
projecting a beam from the light pattern generator across the defined area and producing an optical pattern;
observing with a digital imaging device the optical pattern at an off-set angle to the projected beam;
storing in a memory an image of a non-obstruction pattern produced by projecting the pattern across the defined area in absence of an obstacle;
detecting by the digital imaging device a present optical pattern;
periodically comparing the present optical pattern with the stored image; and
producing a control signal when the present optical pattern differs from the stored image in the memory as a result of an obstruction in the defined area.

19. The method of claim 18, comprising generating an alarm signal responsive to the control signal.

20. The method of claim 18, comprising controlling a movement of a barrier in the defined area in response to the control signal.

21. A barrier operator for moving a barrier along a barrier path between open and closed positions comprising:
a light pattern generator to project an optical beam across the barrier path;
an imaging device to observe the barrier path as illuminated by the optical beam; and
a controller coupled to the imaging device to sense an obstacle illuminated by the optical beam.

22. A barrier operator for moving a barrier between open and closed positions with respect to a barrier opening comprising:
a light pattern generator to project an optical beam across the barrier path, said light pattern generator having the ability to be enabled and disabled;
an imaging device to observe the barrier opening;
a controller coupled to the imaging device to detect an enabled image of the barrier opening while the light pattern generator is enabled and to detect a disabled image of the barrier opening while the light pattern generator is disabled and generating a detection signal in response to the enabled and disabled images.

23. A method of detecting an object in a defined area using a light pattern generator and a digital imaging device, comprising steps of:
projecting a beam from the light pattern generator across the defined area;
observing with a digital imaging device an optical illumination in the defined area;
storing in a memory an image of a non-obstruction optical illumination produced by projecting the pattern across the defined area in absence of an obstacle;
detecting by the digital imaging device a present optical illumination pattern;
periodically comparing the present optical illumination pattern with the stored image; and
producing a control signal when the present optical illumination pattern differs from the stored image in the memory as a result of an obstruction in the defined area.

24. The method of claim 23, comprising generating an alarm signal responsive to the control signal.

25. The method of claim 23, comprising controlling a movement of a barrier in the defined area in response to the control signal.
